(19) United States
(12) Patent Application Publication
(10) Pub. No.: US 2010/0268686 A1
(43) Pub. Date: Oct. 21, 2010

(54) System and method for student-centered learning

(76) Inventor: Alcott Alda Hekima Germany, II, Southfield, MI (US)

Correspondence Address: Jacob Chang, 5322 Corbin Dr., Troy, MI, 48098, US

(21) Appl. No.: 12/386,226

(22) Filed: Apr. 15, 2009

(51) Int. Cl. G06F 17/00

(52) U.S. Cl. 707/608; 707/E17.019

(57) ABSTRACT

The subjective nature of student development provides numerous variables that make it difficult for teachers to understand the root cause of the problem areas for each student. Understanding what elements of instruction are understood by student provides teacher a significant edge on how to design instructional tactics that will allow student to effectively ascertain the lesson material on a cognitive level, thereby developing a student's understanding on how to apply lesson concepts and improve retention of the material needed in achieving high proficiency scores.

The Student-Centered Learning System provides teachers with an effective instructional tool to allow teachers to pinpoint a student's level of cognitive understanding. By using real-time data, teachers, parents, and students will have a clear understanding of where deficiencies and misunderstandings exist that will allow a teacher to have a clearer approach in how to proceed with their planning strategies.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of classroom education and more specifically to a system and method for student-centered learning.

The issues facing student achievement in classrooms ranging from elementary through the college levels center around poor results when taking assessments as well as an inability to apply what is learned in the field. In primary and secondary schools, teachers are being held more accountable through mandates such as No Child Left Behind (NCLB) and Adequate Yearly Progress (AYP) to ensure that the instruction provided to students is adequate, allowing students to succeed given what is asked of them by schools and employers. Unfortunately, the subjective nature of student development provides numerous variables that make it difficult for teachers to understand the root cause that will allow them to decipher what the problem areas are for each student, especially when class sizes can easily exceed 20 students.

The learning style of a student can vary extremely over several classifications. It can include active and reflective learning, sensing and intuitive learning, visual and verbal learning and sequential and global learning. These different learning style classifications exist in every classroom. Several students may have similar styles, but overall a classroom can very likely have students with a diverse array of many styles. Moreover, the teacher must be able to adhere to these diverse forms of learning in order to provide students with an ample opportunity to utilize what is learned by demonstrating proficiency on assessments. In order for teachers to have success in providing effective instruction, he or she must develop strategy (i.e. lesson plan) that documents their instructional tactics that will allow them to successfully engage the educational needs of the classroom. Understanding what elements of instruction are understood by the student provides the teacher with a significant edge on how to design instructional tactics that will allow the student to effectively ascertain the lesson material on a cognitive level, thereby developing a student's understanding on how to apply lesson concepts and improve retention of the material needed in achieving high proficiency scores. This invention provides teachers with the tools necessary to provide effective instructional tactics by providing real-time data results that will allow teachers to pinpoint a student's level of cognitive understanding. By using real-time data, teachers, parents, and students will have a clear understanding of where deficiencies and misunderstandings exist. This gives the teacher an advantage on how to proceed with their planning strategies.

### BRIEF SUMMARY OF THE INVENTION

The primary objective of the invention is to provide teachers with a standardized template where they can develop effective lesson strategies for their students.

Another objective of the invention is to provide teachers with lesson strategy tools that will allow the user to meet and exceed expectations set up by federal, state and local educational authorities.

Another objective of the invention is to allow teachers to share their lesson strategies with fellow faculty.

A further objective of the invention is to provide a tool for teachers to generate student-centered learning group activities.

Yet another objective of the invention is to allow teachers to easily create scoring rubrics that communicate expectations for performance-based objectives and center on the objectives of the lesson strategy.

Still yet another objective of the invention is to allow teachers to record and manage student group work.

Another objective of the invention is to allow teachers to understand student learning and behavior patterns.

Another objective of the invention is to help teachers decide on the best instructional tactics needed to maximize a student's cognitive development and scholastic performance on objective assessments.

A further objective of the invention is to provide teachers a tool that will allow them to make effective data-driven decisions on teaching activities.

Yet another objective of the invention is to provide a web-based system compatible to any school IT infrastructure.

Other objectives and advantages of the present invention will become apparent from the following descriptions, taken in connection with the accompanying drawings, wherein, by way of illustration and example, an embodiment of the present invention is disclosed.

The Student Centered Learning System (SCLS) provides an IT platform for instructors to implement group learning activities within a lesson plan and utilize a statistical analysis tool to evaluate the impacts of the group learning environment on student performance. As a result, more efficient strategies are designed that directly link cognitive learning strategies to lesson plan development.

The design intent of the invention is to provide teachers with the tools needed to engage the classroom without exhausting efforts in implementing rote learning across a massive audience. Federal, state, and local mandates are requiring that schools place a greater emphasis on developing a student's cognitive understanding in the classroom. As a result, the invention was design to address meeting the “in-classroom” needs of the instructor so that future strategies may be developed outside of the classroom when necessary. The components within the invention design were created through the use of a learning model discussed later in this package. Additionally, this invention is a web based system designed to work on any school intranet server, keeping all data proprietary to the school while still enabling teachers to share ideas and communicate with fellow faculty.

The system has a profile sheet within it that allows the teacher to display information about the classroom itself. This tool provides teachers the ability to organize their students by class and is manually editable. The student profile database within the system allows teachers to organize their student rosters on a per-class basis. Once the student and classroom profiles are entered, this data is automatically saved within the system, where assessment scores for each student and each class is captured.

The Lesson Plan Template operates as the “central hub” to what the teacher will use as a guide in implementing their instructional strategy. The lesson plan template was developed for teachers to develop a standardized lesson strategy that is based on expectations of AYP, NCLB, administrative faculty, and current instructor practice.

The Lesson Strategy Guide Template is a tool within the system that is activated for each lesson with performance-based objectives in the lesson plan. This template functions as a quick fill-in interface that provides a structured group activity as its output. Its design allows for teachers to generate activities to assess a student's cognitive understanding of the lesson material.

The Teacher Observation Sheet contains the master profiles of all the students assigned to a course. This includes individual and group grades as well as student learning and behavior patterns noticed by the teacher. This sheet also helps a teacher decide on the best cognitive learning approach to use for the group learning exercises when developing the Lesson Strategy Guides.

The Classroom and Student Summary sheets provide teachers with a user-friendly analysis tool that measures student performance as individuals and in groups. These report sheets provide teachers with another resource in the system to make data-driven decisions that can lead to making changes in their instructional tactic, propose changes in the curriculum, or request additional resources needed for student development.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is dataflow of the student-centered learning system

FIG. 2 is the group collaboration diagram

FIG. 3 is the lesson strategy guide user sequence

FIG. 4 is the rubric template diagram

FIG. 5 is an example of the lesson strategy guide

FIG. 6 is a rubric rule example

FIG. 7 is the group collaboration example

FIG. 8 is a teacher observation sheet

FIG. 9 is the student summary sheet

FIG. 10 is the classroom data sheet

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

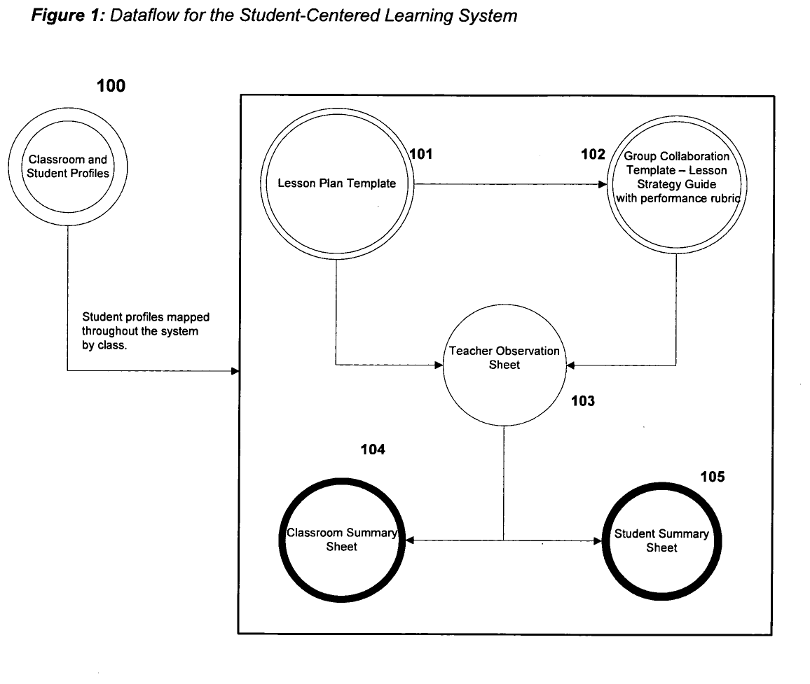

FIG. 1 illustrates a data flow process of student centered learning system. The data system manages student grades and profiles. Student profiles and classroom profiles (100) can be manually entered or automatically imported from external files. This information is mapped throughout the system to reduce the use of manual re-entry by the user when accessing other parts of the system: group collaboration template 102, teacher observation sheet 103, classroom summary sheet 104, and student summary sheet 105. The entire dataflow in FIG. 1 is designed to run on a web-based platform (intranet/internet) on any server using an internal or external network connection. All data recorded by the user is stored on a standard Structured Query Language (SQL) database. Users will also see creation logs for every student and classroom created in the session under the user's profile.

Different from other educational tools, the teacher has full freedom on content inserted. This software platform was designed to address internal classroom execution and analyze results so that an instructor or a collection of instructors can make adjustments in their instructional tactics when necessary. By law, teachers must be aware of the state standards prior to engaging their classrooms. Therefore, the invention focuses on allowing the teacher to create a learning environment using their expertise to decide the best way to deliver information to their students based on curriculum expectations given.

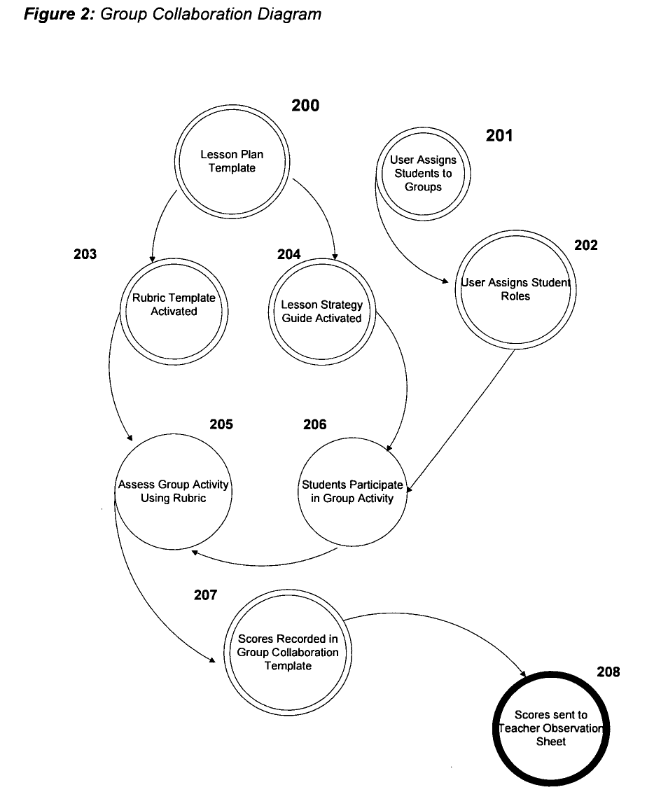

FIG. 2 illustrates a process of creating a lesson plan. The lesson plan is based from the lesson plan template 200. Lesson strategy guide 204 is used to create group activities 206. One of the unique features of the present invention is the group learning model activity 206 that directly maps from the lesson plan 200. Group activities can be very sporadic and cause students and teachers to lose sight of the learning objectives given the verbal activity, movement, and noise level that can result from class group activities, especially in large class sizes. This system is designed to prevent group activity from being look upon as simply an extra-curricular type of exercise surrounded by this type of loss in learning efficiency. Group learning is a vital way in developing cognitive learning skills in the student and communicating essential learning issues and perspectives to the teacher; so in using the lesson plan template, the user can also activate a rubric template 203 to communicate expectations and assess the group activity 205. The scores from the group activity are manually recorded in the group collaboration template 207 by the user where they scores are then fed automatically to Teacher Observation sheet 208 by the system.

The system uses this model design to ensure that there is always a correlation to what is expected by teacher throughout the planning and execution process. The data flow sequence in FIG. 2 illustrates that the Lesson Plan template 200 activates the Student-centered learning/group activity 204, which occurs when the performance-based assessment option in the lesson plan template 200 is selected. Information in the lesson plan template 200 serves as a link of information that is sequenced through the remaining components of the system.

The teacher can assign the students to a group 201 and assign the students with different roles in the group 202. Using the lesson strategy guide template 204, students will interact effectively with one another 206. Using the lesson plan template 200, the teacher will have the option to use a rubric 203 to evaluate their performance activity. The performance-based rubrics 203 are directly correlated to the lesson plan's point value identified for every group activity in the lesson.

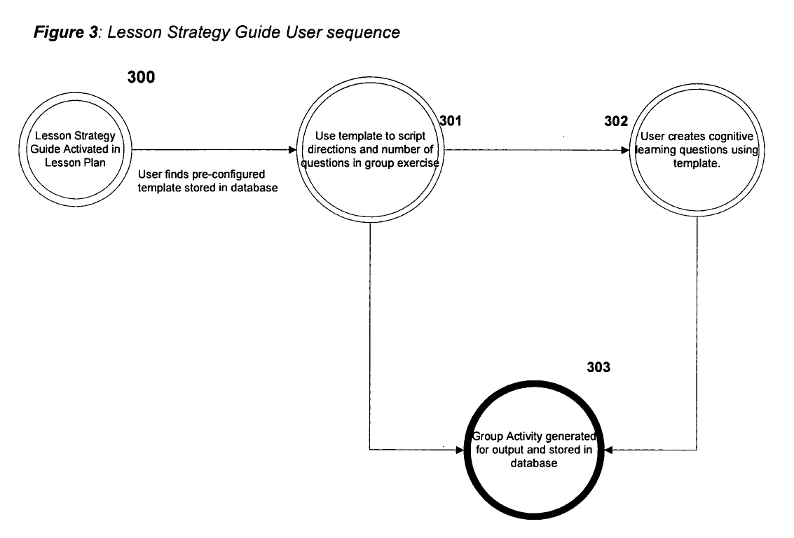

FIG. 3 illustrates a process to create a lesson strategy guide. Teachers can use the lesson strategy guide template 301 stored in the SQL database to script directions and questions for the group exercises. After scripting the directions and number of questions 301 for the exercise, the teacher can develop the cognitive learning questions 302 where the teacher can save the group activity to the database and convert the activity to an online visual or hardcopy format to provide as handouts to their students 303.

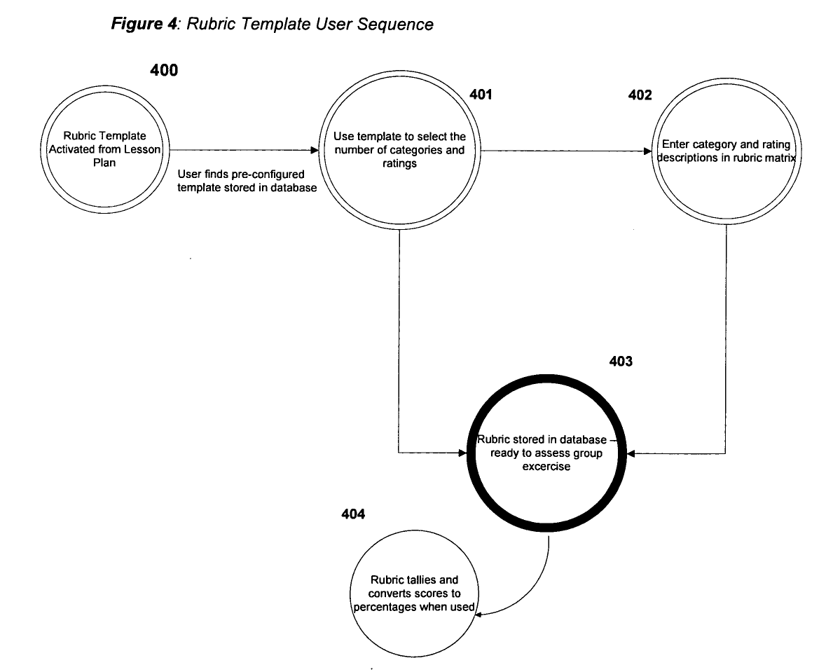

FIG. 4 illustrates a process for the rubric template that is applied for the group learning activities. Once the lesson strategy guide is activated in the lesson plan, the user will have the option to activate the rubric function in the lesson plan. Once activated the user selects the number of categories and ratings 401 from the pre-configured templates 400 in database to create rubric matrix 402. The rubric matrix is applied to a specific group activity and stored in the database 403. The rubric has a calculator tool (404) to help teachers evaluate the work provided by the students. This tool (404) tallies the numeric scores the teacher enters into the rubric.

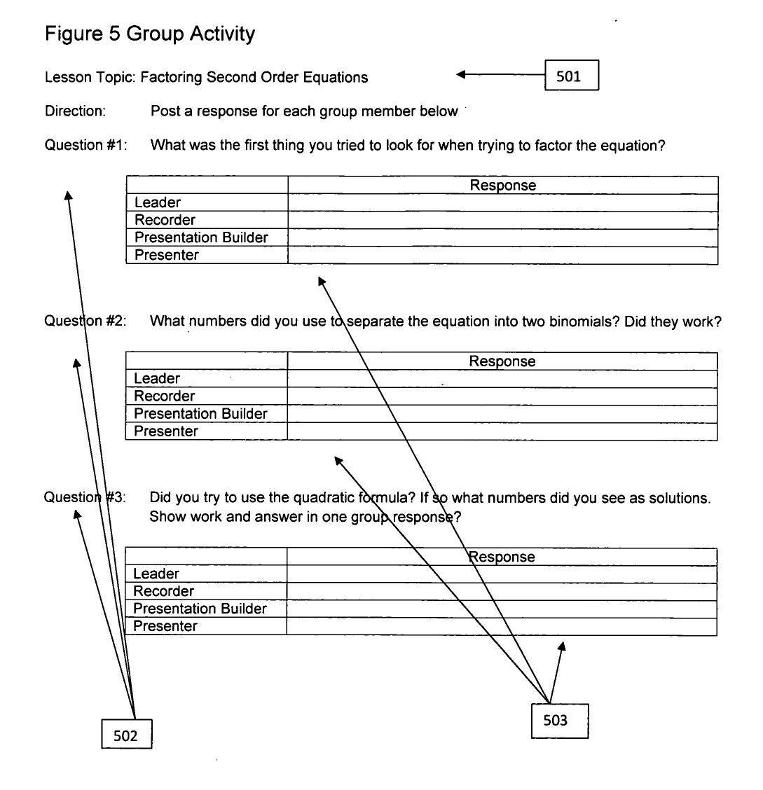

FIG. 5 highlights an example of a group activity. The activity's lesson topic 501 is linked to the lesson plan topic. The number of questions 502, the roles for each group and the answers from the group members 503 are defined in the lesson strategy guide.

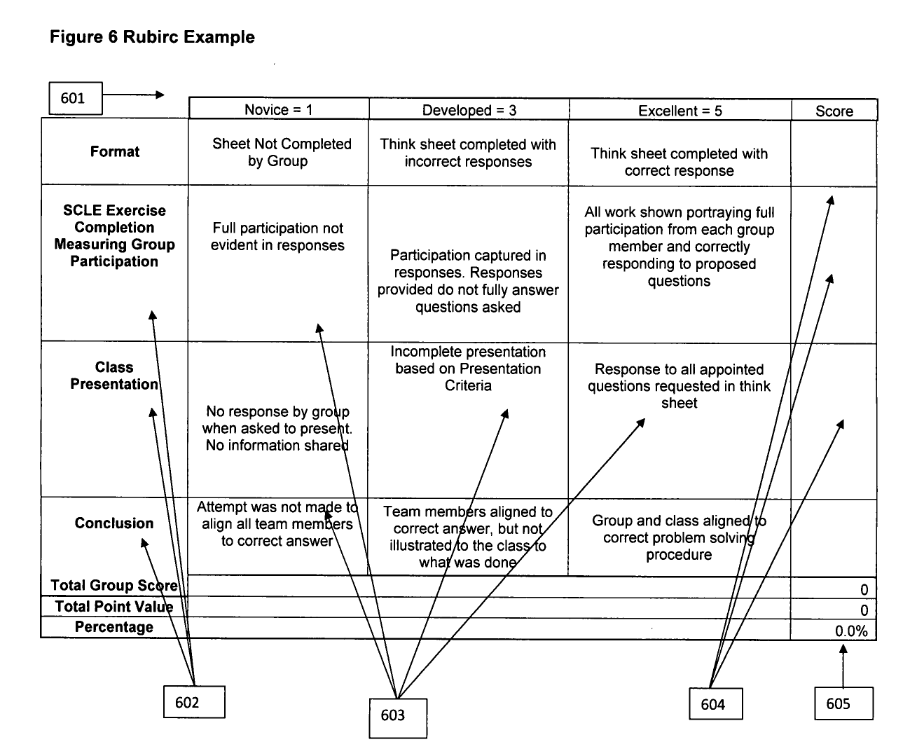

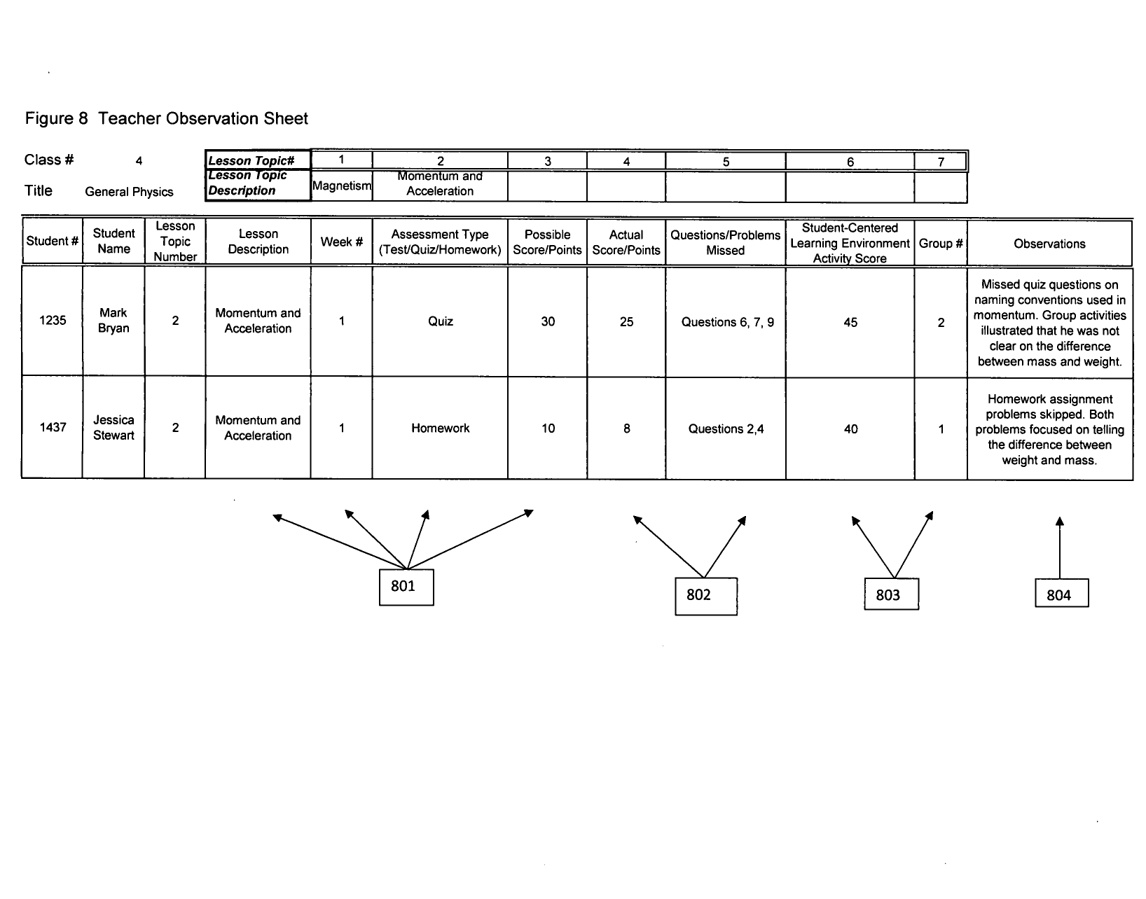

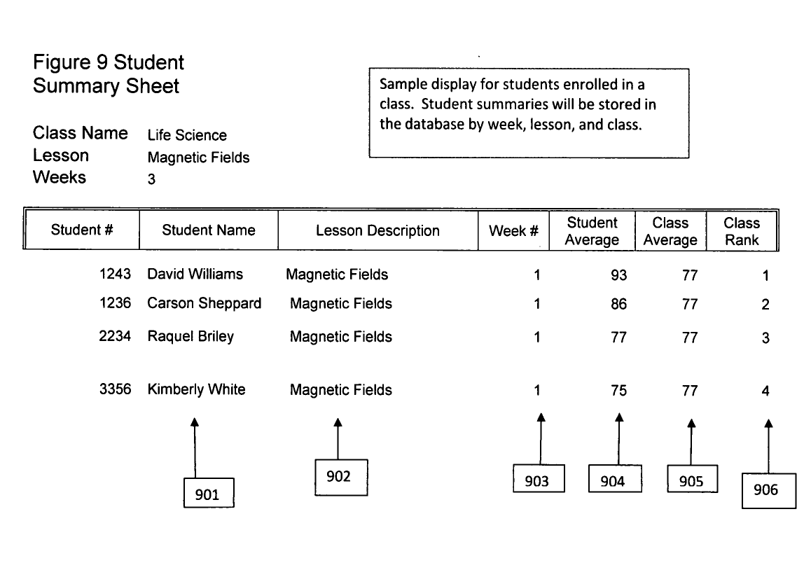

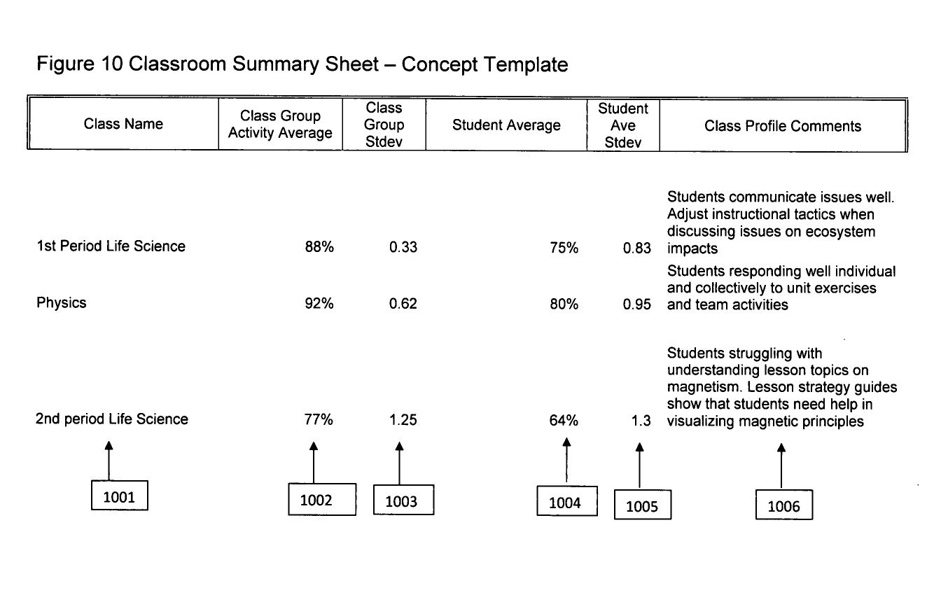

FIG. 6 shows a rubric example. Score scale 601 and score category 602 are created by the rubric template. The rubric has an editable feature 603 and one is created for every lesson strategy guide used for a particular lesson which allows teacher to enter expectations regarding the group activity. Rubrics are essential for assessing performance-based lessons, because of the clear expectations they provide for subjective answers given by students. The rubric calculator tool 404 tallies the numeric scores the teacher enters into the score row at the end of each category row 604, providing a total point score and a percentage score 605 at the bottom of the matrix. The software calculates the percentage by using the total point value assigned to the activity pulled from the lesson plan 101 and dividing that into the total point score from the rubric and then converting that decimal value into a percentage. The percentage score is used to record on the hardcopy Lesson Strategy Guide 303 to submit back to the students (this is a convenience feature; the percentage score is not to be recorded in the system). The total point score is what the user will manually record to the Group Collaboration sheet. From here the grades are automatically sent to the Teacher Observation Sheet FIG. 8 and used by the system to calculate the student performance scores FIG. 9 and classroom performance scores FIG. 10.

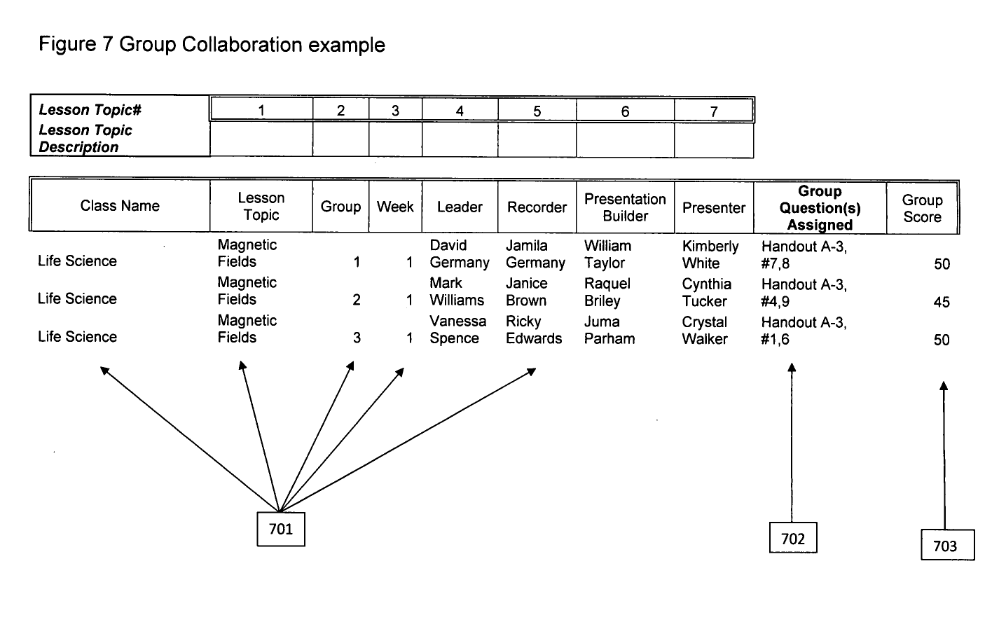

FIG. 7 shows a sample of group collaboration template. Here the class name, lesson topic, group number, week, and student roles 701 are provided using the information from the class and student profiles 100. The questions information 702 is from the group activity 303. To ensure that students receive a diverse learning experience, the group collaboration template allows the user to change student roles within a group.

FIG. 8 displays a sample of teacher observation sheet. Lesson information 801 is derived from lesson plan menu 101. Student score information 802 is manually entered by the user. Group score information 803 is filled from the group collaboration sheet 102. Teacher observation information 804 is entered by users manually based on the in-class observation.

Information in student summary sheet FIG. 9 and classroom summary sheet FIG. 10 is not editable. The calculations seen were extracted from the scores recorded by the user in the teacher observation sheet 802 in FIG. 8 and group collaboration Template 703 in FIG. 7. The scores in both student summary sheet 904, 905 and class summary sheet 1002, 1003, 1004, 1005 are calculated cumulative scores for each student and every classroom from week to week. This allows the user to track student progress to help pinpoint when issues in the classroom occur. The calculations were designed to calculate complex cumulative averages 1002, 1004 and standard deviation, 1003, and 1005 throughout a course for all students profiles registered in the system, for all lessons. Each week the summary sheet will update itself for calculating the mean average for each student 904 and updating their rankings 906 when comparing their grade percentage with each student in the class. The overall class average 1005 is also updated in real-time fashion and organized. The updates are to keep consistent with the schedule created in the lesson plan template 200 (FIG. 2) when assigning the number of weeks to a lesson. Once grades are recorded in the Teacher observation sheet FIG. 8 or group scores are inserted in the group collaboration template FIG. 7 the student and classroom summary sheets begin to calculate scores. The system uses a point value system so that the teacher can properly weigh student assignments. This prevents students having their true assessment performance diluted by every assignment having the same calculation (example, both tests and homework being scored out of 100 to help make calculating easier) weight, preventing teachers from having to make complex judgments on a student's overall performance when trying to weigh out smaller assignments with larger ones. The classroom summary sheet 105 and student summary sheet 104 convert these point value scores into percentages in the output display (1002 and 1004). Moreover, the classroom and student summary sheets provide cumulative grading reports and organize classroom and student grade reports by lesson and by week. This means that after each week and each new lesson, the system calculates the total average and standard deviation for all scores in the system, past and present with the most up-to-date cumulative scores presented in the latest lesson and week uploaded into the system. This allows the teacher to always know a student's latest grade status and follow a trend from week to week on how each student's lesson performance impacts their overall grade.

The output display reporting the class name 1001, class group activity average 1002, class group standard deviation 1003, student average (overall class average—for group activity and individual assignments) 1004 and student average standard deviation 1005 in FIG. 10 provide the user with an overall performance snapshot of every classroom allowing them to compare classes to one another. This additional resource allows a teacher to see how well their instructional deliveries affect different classroom audiences. This invention is not only designed to track trends of a student's performance, but the performance effectiveness of the teacher as well. The class profile comments 1006 allow a teacher to comment on the overall teacher perspective of the classroom.

The teacher observation sheet FIG. 8 contains repository data for all student activity in a classroom. This allows the teacher to have a clear image of a students learning pattern on both objective and performance based assessments. Used in conjunction with the classroom summary sheet FIG. 10, it allows the teacher to have a clear understanding of a student's performance and how their learning patterns compare to what is seen in the classroom. Observations field 804 (FIG. 8) shows the common mistakes made amongst students on tests, quizzes, and homework. The teacher uses this information as a basis to create lesson strategy guides FIG. 3 that focus on identifying the appropriate target areas that a teacher needs to understand to ensure that his or her instructional tactics are valid in order for the classroom to perform consistently at a high achievement level. Lesson plan template FIG. 2 and group collaboration template FIG. 3 function collectively to unify a teacher's delivery to the student's learning style/perspective. The teacher observation sheet FIG. 8 presents how the data is organized for users to insert observations based on what the teacher sees from the assessments provided, lessons learned from the group activities, and see student learning trends. When a user reviews the teacher Observation Sheet FIG. 8, he or she will have a quick snapshot of the learning patterns and learning issues impacting a student's performance, thereby presenting to the instructor possible trends that will show what students are not grasping in the classroom and in what way. The results of this data allows the teacher to make data driven decisions in a two-fold manner, if the learning performance and learning trends are consistent throughout the classroom, the teacher should be compelled to review their own methods; conversely, if the data shows performance patterns by students are random and sporadic, then a teacher may safely conclude that those students may need a unique approach, one that involves individual attention from another program or curriculum. Both inferences using these data tools provide a facilitator with an efficient means of correctly categorizing student and teacher issues, avoiding high level spending on reconfiguring student programs and curriculums that are modified without pertinent data support.

NCLB currently faces issues with creating cohesive educational standards. Because schools are being held more accountable in finding root cause issues to poor student performance, every school across the country is looking for measures and ways to wrap their understanding around how to make the correct decisions to improve schools for the better. Standardized assessment scores provide too much of a macroscopic view to ascertain a valid answer to today's classroom problems. Identifying the correct variables to address on a macro level first involves understanding what is taking place on a micro level. The teacher observation sheet FIG. 8 helps teachers identify the correct variables at that level. The teacher observation sheet, combined with classroom summary sheet FIG. 10 and student summary sheet FIG. 9 provides validated support that the user can use when making claims on necessary adjustments in the instructional tactic, making recommendations in altering a curriculum, or contacting parents on valid concerns regarding a student's learning performance that may require additional resources. This invention creates a learning system based on accountability, helping teachers, students, and parents identify authentic issues so that the correct planning can take place for ground-breaking educational reform.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A system for teacher to create a lesson plan, comprising:
A lesson plan template engine
A database to store the information
A lesson activity template to provide the student activities for the lesson

2. The system of claim 1, wherein the computer integration can be used in the lesson activity

3. The system of claim 1, wherein the assessment can be associated with the lesson activity

4. The system of claim 1, wherein the assessment can be either performance based or objective based, or both

5. The system of claim 4, wherein a rubric will be used in assessing student performance in the lesson for performance based activities

6. A system to create group activity comprising:
A template to create instructions and questions for the group activity

7. The system of claim 6, wherein the group activity can be performed either online or in print-out format

8. The system of claim 6, wherein the group roles can be exchanged

9. The system of claim 6, wherein rubric scoring rules can be associated with the group activity to communicate the expectations of activity

10. The system of claim 9, wherein a calculating engine is associated to calculate the score of the group activity

11. The system of claim 6, wherein the group activity can be associated with a class

12. The system of claim 11, wherein the group activity can be associated with a lesson in a class

13. A system for teacher to track student performance and teaching effectiveness, comprising:
A database for store group activity scores
A point value system to allow the scores to be properly weighed
A calculation engine to calculate the group activity average, group activity standard deviation, class assessment average and classroom activity standard deviation

14. The system of claim 13, wherein a mean is provided for teacher to record his/her observation of student group activities

15. The system of claim 13, wherein the teacher can create additional group activities for students to collaboratively work on the area they struggled based on the teacher's observation

16. The system of claim 13, wherein the teacher can pinpoint the area that the students struggle

17. The system of claim 13, wherein the class group average and standard deviation will be used to determine the uniformity of how well students understand the material and the effectiveness of the teacher's instruction

18. The system of claim 13, wherein the class average and standard deviation can be calculated to help the teacher assess the effectiveness of the lesson activity
